(19) United States
(12) Patent Application Publication
(10) Pub. No.: US 2026/0087830 A1
(43) Pub. Date: Mar. 26, 2026

(54) APPARATUS, DEVICE AND METHOD FOR PERFORMING A PERCEPTION TASK, AND CORRESPONDING COMPUTER-READABLE STORAGE MEDIUM

(71) Applicant: QUALCOMM Incorporated, San Diego, CA (US)

(72) Inventors: Venkatraman Narayanan, Northville, MI (US); Varun Ravi Kumar, San Diego, CA (US); Senthil Kumar Yogamani, San Diego, CA (US)

(21) Appl. No.: 18/891,090

(22) Filed: Sep. 20, 2024

(51) Int. Cl. G06V 20/64; G06T 7/521; G06T 7/55; G06T 7/70; G06V 10/26; G06V 10/40; G06V 10/80; G06V 20/56

(52) U.S. Cl. CPC G06V 20/64; G06T 7/521; G06T 7/55; G06T 7/70; G06V 10/26; G06V 10/40; G06V 10/806; G06V 20/56; G06T 2207/10028; G06T 2207/10044; G06T 2207/20221; G06T 2207/30252

(57) ABSTRACT

An apparatus may be configured to perform a perception task based on features fused with height information. The apparatus configured may generate 3D sensor features from data from one or more sensors, generate a plurality of height maps from the 3D sensor features at a plurality of times, generate a height gradient map from the plurality of height maps, fuse the 3D sensor features and the height gradient map to generate height informed fused features, and perform the perception task using the height informed fused features.

### TECHNICAL FIELD

This disclosure relates to computer vision techniques.

### BACKGROUND

Computer vision applications, including applications in automotives, make use of the detection and analysis of three-dimensional (3D) objects. 3D object detection may include the identification and localization of objects in 3D space using sensors like cameras, LiDAR, and radar. Algorithms process this data to recognize and position objects accurately, enhancing real-time situational awareness.

Example computer vision tasks for automotive application include semantic occupancy prediction, semantic segmentation, lane tracking, and 3D object detection. Semantic occupancy prediction involves predicting the presence and category of objects in a 3D space, typically represented as a grid or voxel space, helping to understand the structure and content of the environment. Semantic segmentation is the process of classifying each pixel in an image into predefined categories, enabling more precise identification and localization of different objects and regions within the image. Lane tracking involves identifying and following lane markings in images or video frames, which is important for autonomous driving systems to navigate and stay within traffic lanes accurately. 3D object detection aims to identify and localize objects within a 3D space, providing detailed information about the position, dimensions, and categories of objects in the environment.

### SUMMARY

In general, this disclosure describes techniques for performing perception tasks that may be used in computer vision and automotive use cases. In particular, this disclosure describes techniques for height informed birds-eye-view (BEV) perception. The techniques of this disclosure include the incorporation of explicit height modeling along with BEV space features.

Incorporating explicit height modeling along with BEV space features may be useful for adapting to varying terrains and accurately representing the environment. Addressing these challenges may improve the performance of autonomous driving technology in real-world environments. To overcome the limitations associated with implicit height modeling, this disclosure describes techniques that integrate explicit heightmaps alongside BEV features in order to extract more accurate object dimensions and positions. Explicit height encoding enhances depth perception by providing additional depth cues. This enables more accurate estimation of object distances, positions, and dimensions, particularly in scenarios where objects are partially obscured or occluded. By utilizing explicit heightmaps, the techniques of this disclosure capture the vertical dimension of the environment, providing a more comprehensive understanding of terrain variations and object heights.

Some examples of this disclosure use BEV features that include fused camera features and LiDAR features. However, any combination of sensors (including camera only) may be used with the techniques of this disclosure. The BEV features encode the likely (e.g., estimated) depth of an object from the sensors, highlighting regions where objects are expected to be present, whereas the heightmap captures the elevation of the object with respect to the sensors.

In one example, this disclosure describes an apparatus configured for performing a perception task, the apparatus comprising a memory, and processing circuitry connected to the memory, the processing circuitry configured to generate 3D sensor features from data from one or more sensors, generate a plurality of height maps from the 3D sensor features at a plurality of times, generate a height gradient map from the plurality of height maps, fuse features from at least the 3D sensor features and the height gradient map to generate height informed fused features, and perform the perception task using the height informed fused features.

In another example, this disclosure describes a method for performing a perception task, the method comprising generating 3D sensor features from data from one or more sensors, generating a plurality of height maps from the 3D sensor features at a plurality of times, generating a height gradient map from the plurality of height maps, fusing features from at least the 3D sensor features and the height gradient map to generate height informed fused features, and performing the perception task using the height informed fused features.

In another example, this disclosure describes a device for performing a perception task, the device comprising means for generating 3D sensor features from data from one or more sensors, means for generating a plurality of height maps from the 3D sensor features at a plurality of times, means for generating a height gradient map from the plurality of height maps, means for fusing features from at least the 3D sensor features and the height gradient map to generate height informed fused features, and means for performing the perception task using the height informed fused features.

In another example, this disclosure describes a non-transitory computer-readable storage medium storing instructions that, when executed, cause one or more processors of a device configured to perform a perception task to generate 3D sensor features from data from one or more sensors, generate a plurality of height maps from the 3D sensor features at a plurality of times, generate a height gradient map from the plurality of height maps, fuse features from at least the 3D sensor features and the height gradient map to generate height informed fused features, and perform the perception task using the height informed fused features.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle in accordance with the techniques of this disclosure for height informed perception.

FIG. 2 is a block diagram illustrating an example system that may perform the techniques of this disclosure for height informed perception.

FIG. 3 is a block diagram illustrating one example of height informed perception in accordance with the techniques of this disclosure.

FIG. 4 is a flowchart illustrating an example process in accordance with the techniques of this disclosure.

### DETAILED DESCRIPTION

Computer vision techniques, including techniques for autonomous driving and advanced driver assistance systems (ADAS), may analyze sensor data in a birds-eye-view (BEV) representation. A BEV representation may include data from one or more sensors, including cameras, LiDAR sensors, radar sensors, and others. Existing BEV representation methods primarily focus on implicitly modeling the height of object within the BEV space. Implicit modeling includes estimating heights of objects without using explicit height data. However, this lack of explicit height modeling results in inaccuracies, especially in terrains with varying elevations, due to oversimplified assumptions about flat-earth surfaces. Specifically, objects like traffic lights and signs are often mounted on poles or structures and lack height context in conventional BEV representations. This absence of height information poses challenges in accurately detecting and localizing objects, which may be important for autonomous driving systems.

In general, this disclosure describes techniques for performing perception tasks that may be used in computer vision and automotive use cases. In particular, this disclosure describes techniques for height informed birds-eye-view (BEV) perception. The techniques of this disclosure include the incorporation of explicit height modeling along with BEV space features.

Incorporating explicit height modeling along with BEV space features may be useful for adapting to varying terrains and accurately representing the environment. Addressing these challenges may improve the performance of autonomous driving technology in real-world environments. To overcome the limitations associated with implicit height modeling, this disclosure describes techniques that integrate explicit heightmaps alongside BEV features in order to extract more accurate object dimensions and positions. Explicit height encoding enhances depth perception by providing additional depth cues. This enables more accurate estimation of object distances, positions, and dimensions, particularly in scenarios where objects are partially obscured or occluded. By utilizing explicit heightmaps, the techniques of this disclosure capture the vertical dimension of the environment, providing a more comprehensive understanding of terrain variations and object heights.

Some examples of this disclosure use BEV features that include fused camera features and LiDAR features. However, any combination of sensors (including camera only) may be used with the techniques of this disclosure. The BEV features encode the likely (e.g., estimated) depth of an object from the sensors, highlighting regions where objects are expected to be present, whereas the heightmap captures the elevation of the object with respect to the sensors.

In one example, this disclosure describes an apparatus configured for performing a perception task, the apparatus comprising a memory, and processing circuitry connected to the memory, the processing circuitry configured to generate 3D sensor features from data from one or more sensors, generate a plurality of height maps from the 3D sensor features at a plurality of times, generate a height gradient map from the plurality of height maps, fuse features from at least the 3D sensor features and the height gradient map to generate height informed fused features, and perform the perception task using the height informed fused features.

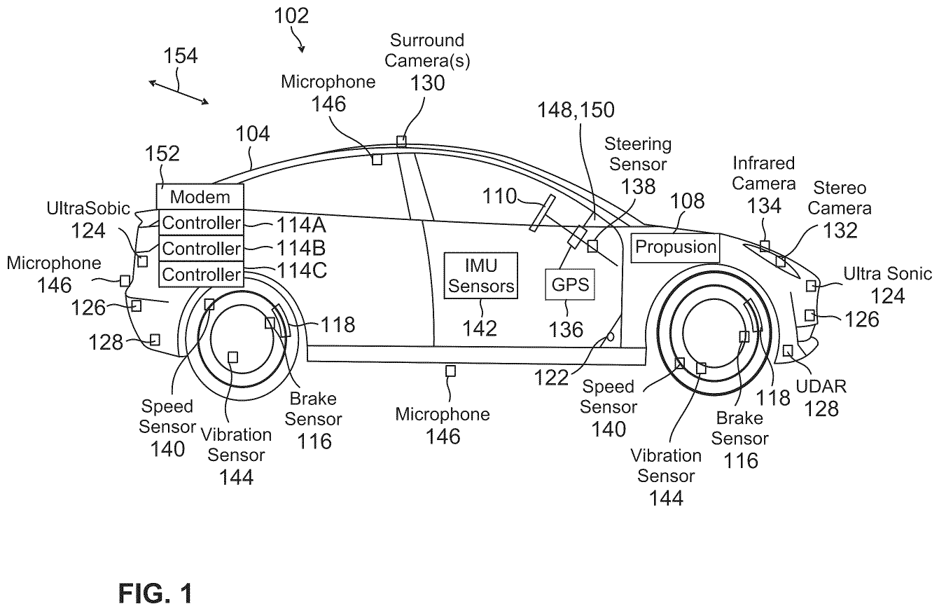

FIG. 1 shows an example vehicle 102 that may be configured to perform the height informed perception tasks of this disclosure. Vehicle 102 in the example shown may comprise a passenger vehicle such as a car or truck that can accommodate a human driver and/or human passengers. In one example, vehicle 102 may comprise an autonomous vehicle, semi-autonomous vehicle and may include an ADAS. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs from the following sensors, including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in one example, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller 114 has identified the presence of a stop sign, caution sign, or changing traffic light and is taking appropriate action, giving the vehicle occupants peace of mind that the controller 114 is functioning as intended. In one example, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

As discussed above, computer vision techniques, including techniques for autonomous driving ADAS, may analyze sensor data in a BEV representation. A BEV representation in computer vision refers to a top-down perspective of a scene, as if viewed from above, similar to the perspective of a bird flying overhead. A BEV representation is particularly valuable in applications such as autonomous driving, robotics, and surveillance, where understanding the spatial layout and relationships between objects on the ground plane is beneficial.

In the context of computer vision, generating a BEV representation involves transforming image data from one or more cameras into a top-down view. This process often uses algorithms to account for perspective distortions and accurately projects objects'positions on the ground plane. BEV representations can provide a comprehensive overview of the environment, including the relative positions of vehicles, pedestrians, road markings, and other relevant features.

This top-down perspective simplifies various tasks in computer vision, such as object detection, tracking, and path planning, by reducing the complexity of the scene and offering a more intuitive understanding of spatial relationships. Additionally, BEV representations are often integrated with data from other sensors, such as LiDAR or radar, to enhance accuracy and robustness in dynamic and complex environments.

Existing BEV representation methods primarily focus on implicitly modeling the height of object within the BEV space. Implicit modeling includes estimating heights of objects without using explicit height data. However, this lack of explicit height modeling results in inaccuracies, especially in terrains with varying elevations, due to oversimplified assumptions about flat-earth surfaces.

The difference between implicitly and explicitly modeling object heights in the context of computer vision lies in how the height information is derived and utilized within the system. Implicit modeling of object heights may include inferring height information indirectly through patterns and correlations learned by algorithms, typically machine learning models like convolutional neural networks (CNNs). These models are trained on large datasets where they learn to associate certain visual features and contextual cues with the heights of objects. For instance, the network might learn that certain shadows, sizes, or shapes in a 2D image suggest a particular height. This method relies heavily on the model's ability to generalize from training data and does not require direct measurements of height during inference.

Explicit modeling of object heights, on the other hand, involves directly measuring or calculating the height of objects using specific data or sensor inputs. This approach may use 3D sensors such as LiDAR or stereo cameras, which can capture depth information. LiDAR sensors, for example, emit laser pulses and measure the time it takes for them to return after reflecting off objects, directly providing distance (and thus height) information. Stereo cameras work by comparing images from two slightly offset lenses to compute depth. Explicit modeling provides precise and accurate height measurements, which can be crucial for applications requiring high levels of detail and reliability, such as advanced navigation and obstacle avoidance in complex environments.

Explicit height modeling may be useful for certain objects in the context of automotive use cases. For example, objects like traffic lights and signs are often mounted on poles or structures and lack height context in conventional BEV representations. An absence of height information poses challenges in accurately detecting and localizing objects, which may be important for autonomous driving systems.

In general, this disclosure describes techniques for performing perception tasks that may be used in computer vision and automotive use cases. In particular, this disclosure describes techniques for height informed BEV perception. The techniques of this disclosure include the incorporation of explicit height modeling along with BEV space features.

Incorporating explicit height modeling along with BEV space features may be useful for adapting to varying terrains and accurately representing the environment. Addressing these challenges may improve the performance of autonomous driving technology in real-world environments. To overcome the limitations associated with implicit height modeling, this disclosure describes techniques that integrate explicit heightmaps alongside BEV features in order to extract more accurate object dimensions and positions. Explicit height encoding enhances depth perception by providing additional depth cues. This enables more accurate estimation of object distances, positions, and dimensions, particularly in scenarios where objects are partially obscured or occluded. By utilizing explicit heightmaps, the techniques of this disclosure capture the vertical dimension of the environment, providing a more comprehensive understanding of terrain variations and object heights.

Some examples of this disclosure use BEV features that include fused camera features (e.g., from one or more of cameras 130) and LiDAR features (e.g., from LiDAR sensor 128). However, any combination of sensors (including camera only) may be used with the techniques of this disclosure. The BEV features encode the likely (e.g., estimated) depth of an object from the sensors, highlighting regions where objects are expected to be present, whereas the heightmap captures the elevation of the object with respect to the sensors. The techniques of this disclosure include the integration explicit heightmaps with BEV features to enhance outdoor perception, which may be very useful for autonomous driving and robotics applications in certain contexts.

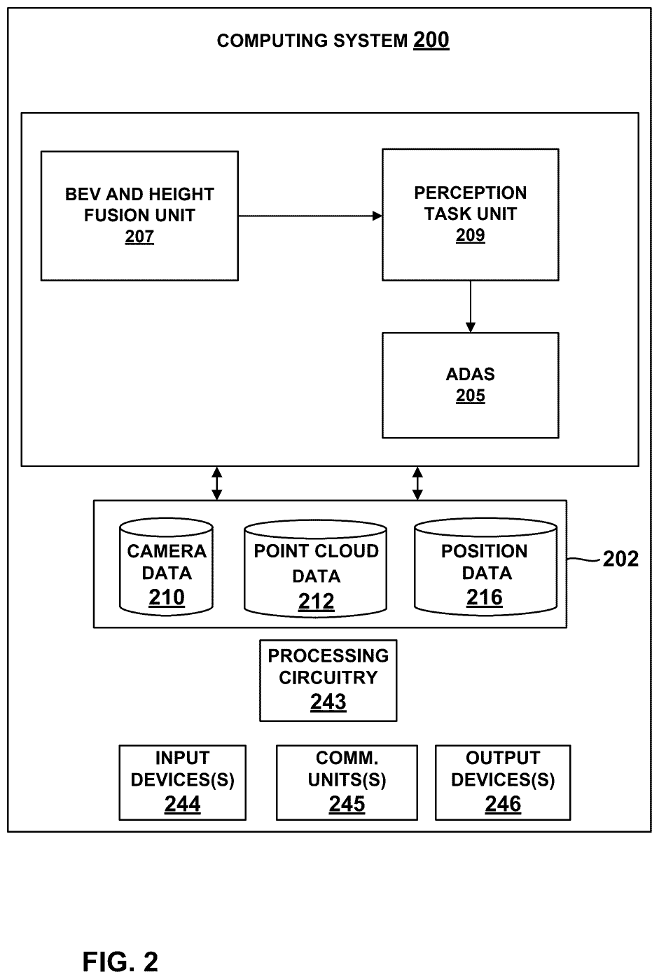

In one example, controller 114 may be configured to generate 3D sensor features from data from one or more sensors, generate a plurality of height maps from the 3D sensor features at a plurality of times, generate a height gradient map from the plurality of height maps, fuse features from at least the 3D sensor features and the height gradient map to generate height informed fused features, and perform the perception task using the height informed fused features. Additional details on the height informed perception techniques of this disclosure are described below with reference to FIGS. 2-4.

FIG. 2 is a block diagram illustrating an example computing system 200. As shown, computing system 200 comprises processing circuitry 243 and memory 202. The processing circuitry 243 is configured for executing BEV and height fusion unit 207, perception task unit 209, and ADAS 205, which may represent an example instance of any controller 114 described in this disclosure, such as controller 114 of FIG. 1. The example of FIG. 2 shows BEV and height fusion unit 207, perception task unit 209, and ADAS 205 as being separate units. In other examples, BEV and height fusion unit 207 and perception task unit 209 may be a sub-units of ADAS 205.

Computing system 200 also be implemented as any suitable external computing system accessible by controller 114, such as one or more server computers, workstations, laptops, mainframes, cloud computing systems, High-Performance Computing (HPC) systems (e.g., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure for height informed perception tasks may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network - PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/deactivate cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., BEV and height Fusion unit 207, perception task unit 209, and/or ADAS 205), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute BEV and height Fusion unit 207, perception task unit 209, and/or ADAS 205 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a video camera, ranging sensor (e.g., one or more of radar, sonar, LiDAR, etc.), keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, computing system 200 may be configured to execute BEV and height fusion unit 207, perception task unit 209, and ADAS 205. Perception task unit 209 may be configured to perform one or more perception tasks using height informed fused features generated by BEV and height fusion unit 207. BEV and height fusion unit 207 may be configured to generate 3D sensor features from data from one or more sensors. In one example, the one or more sensors include a camera sensor (e.g., one of cameras 130 of FIG. 1) that produces camera data 210, and a LiDAR sensor (e.g., LiDAR sensor 128 of FIG. 1) that produces point cloud data 212.

In this example, to generate the 3D sensor features from the one or more sensors, BEV and height fusion unit 207 may be configured to receive point cloud data 212 from the LiDAR sensor, and generate, using a first feature extractor, LiDAR 3D features from point cloud data 212. BEV and height fusion unit 207 may be further configured to receive camera data 210 from the camera sensor, and generate, using a second feature extractor, camera features from the camera data.

In another example, the one or more sensors include only one or more camera sensors. In other examples, the one or more sensors include a camera sensor and a radar sensor, or a camera sensor and a sonar sensor.

BEV and height fusion unit 207 may be further configured to perform a 2D to 3D lifting operation on the camera features to generate camera 3D features. In some examples, BEV and height fusion unit 207 may perform the 2D to 3D lifting operation using learned projections and the point cloud data as supervision data.

BEV and height fusion unit 207 may be further configured to generate a plurality of height maps from the 3D sensor features (e.g., comprising the LiDAR 3D features and the camera 3D features) at a plurality of times. In one example, to generate the plurality of height maps from the 3D sensor features at the plurality of times, BEV and height fusion unit 207 may process respective LiDAR 3D features and respective camera 3D features with a height encoder at each of the plurality of times to produce the plurality of height maps. In one example, the height encoder uses point cloud data 212 as supervision data.

BEV and height fusion unit 207 may be further configured to generate a height gradient map from the plurality of height maps. To generate the height gradient map from the plurality of height maps, BEV and height fusion unit 207 may be configured to compute height gradients from the plurality of height maps, and combine the height gradients with position encoding to generate the height gradient map. In one example, the position encoding uses position data 216 obtained from a vehicle (e.g., vehicle 102). Position data 216 may include one or more of location information and pose information for the vehicle. For example, position data 216 may be used to guide the fusion process to align BEV features from multiple timeframes. Position data 216 can be as simple as an ego pose change from one frame to another or 3D sceneflow vectors from two consecutive frames. The height gradient map may include information indicating temporal variations in height over time in an area around the one or more sensors.

BEV and height fusion unit 207 may be further configured to fuse the 3D sensor features and the height gradient map to generate height informed fused features. In one example, to fuse the 3D sensor features and the height gradient map to generate height informed fused features, BEV and height fusion unit 207 may be configured to fuse the 3D sensor features and the height gradient map using a transformer encoder with a self-attention mechanism to generate height informed fused features.

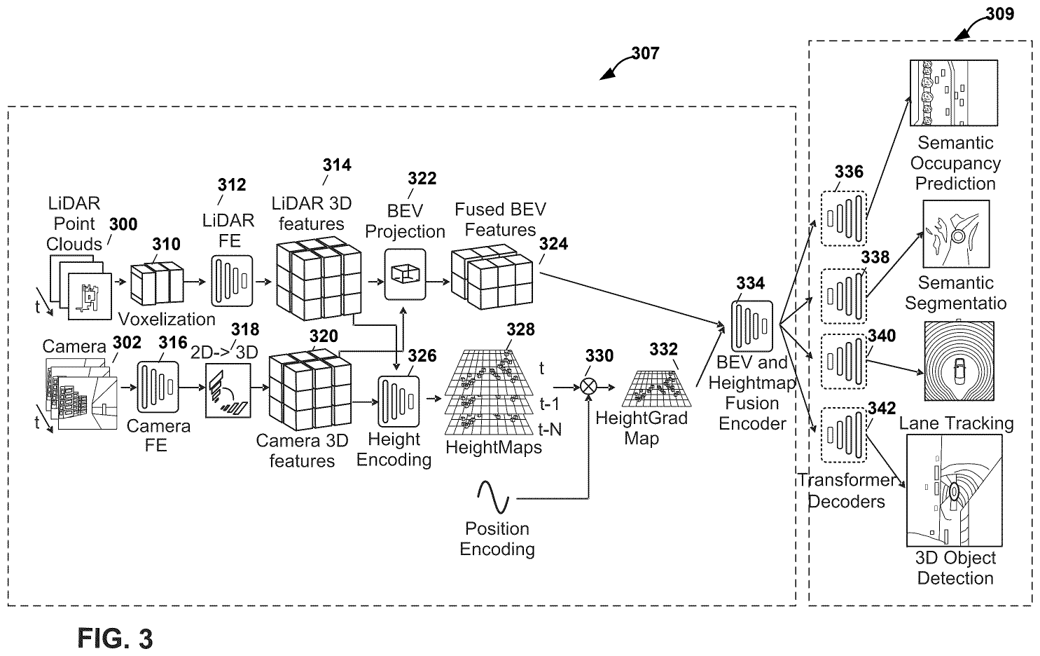

BEV and height fusion unit 207 may provide the height informed fused features to perception task unit 209. Perception task unit 209 may be configured to perform a perception task using the height informed fused features. For example, perception task unit 209 may perform the perception task with a task-specific decoder using the height informed fused features as input. The perception task may include one or more of sematic segmentation, semantic occupancy prediction, lane tracking, or 3D object detection. ADAS 205 may be configured to control a vehicle at least in part based on an output of the perception task. A more detailed description of the operation of BEV and height fusion unit 207 and perception task unit 209 is described below with reference to FIG. 3.

FIG. 3 is a block diagram illustrating one example of the BEV and height fusion unit 207 and perception task unit 209 of FIG. 2. FIG. 3 shows BEV and height fusion unit 307 that is one example of BEV and height fusion unit 207 of FIG. 2. FIG. 3 also shows perception task unit 309 that is one example perception task unit 209 of FIG. 2.

BEV and height fusion unit 307 may be configured to generate 3D sensor feature from one or more sensors. As shown in FIG. 3, BEV and height fusion unit 307 receives point cloud data 300 from a LiDAR sensor (e.g., LiDAR sensor 128 of FIG. 1) and camera data 302 from one or more camera sensors (e.g., cameras 130 of FIG. 1). Camera data 302 may be individual frames of video data or still images captured at different times. Similarly, point cloud data 300 may be individual frames of point cloud data captured at different times.

Voxelization unit 310 may be configured to convert point cloud data 300 into a voxelized representation, which is called the voxelized point cloud data. Voxelization of a LiDAR point cloud is a process that converts the raw point cloud data, which includes a large number of individual 3D points, into a structured, grid-like representation called voxels. A voxel, or volumetric pixel, is a cubic unit in a 3D grid that represents a specific portion of space. Voxelization unit 310 may operate according to a size and resolution of the voxel grid, which determines the level of detail in the final representation. This grid divides the entire spatial domain of the point cloud into discrete, uniformly sized cubes. Voxelization unit 310 may analyze each voxel to determine whether the voxel contains any points from the original point cloud data.

During the voxelization process, voxelization unit 310 assigns each point from the LiDAR point cloud to its corresponding voxel based on its spatial coordinates. If a point falls within the boundaries of a voxel, voxelization unit 310 marks that voxel as occupied. Various algorithms can be used to populate the voxel grid, including occupancy grids or more sophisticated methods that account for point density, intensity values, or other attributes. This transformation simplifies the raw data, making it easier to process and analyze. By aggregating points into voxels, the complexity of the point cloud is reduced, and the data becomes more manageable for subsequent processing tasks such as object detection, segmentation, and classification.

The voxelized representation of point cloud data 300 offers several advantages. The voxelized representation provides a structured and regularized form of the data, which is beneficial for various computational algorithms and machine learning models that operate on uniform input formats. Additionally, voxelization facilitates efficient spatial queries and operations, such as collision detection and nearest-neighbor searches, by leveraging the grid structure. Furthermore, the voxel grid can be easily integrated with other sensor data or used in simulations and visualizations to provide a more comprehensive understanding of the environment.

BEV and height fusion unit 307 may be configured to generate, using a first feature extractor (e.g., LiDAR feature extractor (FE) 312), LiDAR 3D features 314 from the voxelized point cloud data, and generate, using a second feature extractor (e.g., camera feature extractor (FE) 316), camera features from camera data 302. Camera feature extractor 316 and LiDAR feature extractor 312 may be sensor-specific feature extractors that are configured to operate on specific data types to produce feature vectors. Feature vectors are high-dimensional representations that encapsulate the characteristics of an image or point cloud in a compact form. One of several techniques may be used to generate feature vectors. Example techniques for feature extraction are described below.

One example for generating feature vectors uses a Scale-Invariant Feature Transform (SIFT), which detects key points in image data or point cloud data and describes them using local gradients. SIFT features are robust to changes in scale, rotation, and illumination, making them suitable for matching and recognition tasks. Another approach for feature vector generation is a Histogram of Oriented Gradients (HOG), which captures the distribution of gradient orientations in localized regions of an image data or point cloud data. HOG features are particularly effective for detecting objects and shapes, as they highlight edge information and structural patterns.

Another technique for feature vector generation uses convolutional neural networks (CNNs). CNNs include multiple layers of convolutional filters that learn to detect various patterns, such as edges, textures, and complex shapes, through hierarchical feature learning. CNNs are trained on large datasets and can generalize well to new image data or point cloud data. The output from the next to last layer of a CNN, often called the feature map, is typically flattened into a feature vector.

In other examples, vision transformers (ViTs) may be used for feature extraction. ViTs divide image data or point cloud data into smaller patches, treat each patch as a token, and process these tokens using self-attention mechanisms. This approach allows the model to capture long-range dependencies and contextual relationships across the entire image or point cloud.

In other examples, features may be extracted using a transformer encoder. Feature extraction using a transformer encoder involves leveraging a self-attention mechanism to capture complex dependencies and contextual information from input data, such as image data or point cloud data. Transformer encoders, originally designed for natural language processing tasks, have been adapted for various applications in computer vision due to their ability to model long-range relationships and global context effectively.

The process begins with dividing the input data into smaller, manageable units. In the case of image data or point cloud data, this involves splitting the input data into patches. Each patch is then flattened and embedded into a high-dimensional space using a learnable linear projection. Positional embeddings may be added to these patch embeddings to retain spatial information.

Once the patches are prepared, they are fed into the transformer encoder, which may include multiple layers of self-attention and feed-forward networks. Each encoder layer may have two main components: a multi-head self-attention mechanism and a position-wise feed-forward network. The self-attention mechanism computes attention scores for each patch relative to all other patches, allowing the model to focus on relevant parts of the input data contextually. These attention scores are used to weight the patches, capturing dependencies and interactions between different parts of the input data.

The multi-head self-attention mechanism enhances this process by allowing the model to attend to multiple aspects of the data simultaneously. The multi-head self-attention mechanism does so by projecting the input into several subspaces (e.g., heads), performing self-attention in each subspace independently, and then concatenating the results. This enables the model to capture diverse features and relationships from different perspectives.

Following the self-attention mechanism, the output may be processed by a position-wise feed-forward network, which may include two linear transformations with a rectified linear unit (ReLU) activation in between. The ReLU applies non-linear transformations to each patch independently, further refining the extracted features. The output from the feed-forward network is then passed to the next encoder layer, and this process is repeated for a predetermined number of layers. At the end of the transformer encoder, the output feature vectors from the final layer represent a set of features extracted from the input data.

Next, BEV and height fusion unit 307 may extract height features from the camera features produced by camera feature extractor 316 and from LiDAR 3D features 314. Point cloud data 300 from a LiDAR sensor provides direct 3D information about the environment, including the height of objects relative to the ground. Voxel-based representations or point clouds generated from a LiDAR sensor can be utilized to extract height information. To encode height data from camera features, BEV and height fusion unit 307 may apply a 2D to 3D lifting operation 318 to camera features produced by camera feature extractor 316 to generate camera 3D features 320. 2D to 3D lifting operation 318 may use learned projections and depth supervision from point cloud data 300 (e.g., using LiDAR 3D features 314).

As one example, 2D to 3D lifting operation 318 may generate 3D camera features through a process of implicit unprojection (e.g., using a lift, splat, shoot technique), which involves transforming the 2D pixel coordinates into 3D space. 2D to 3D lifting operation 318 may first perform a “lifting” operation, where for each pixel in the image, a distribution over possible depths is predicted. Instead of directly determining the depth of each pixel, 2D to 3D lifting operation 318 generates a frustum-shaped set of points that represent possible locations the pixel could map to in 3D space.

Each pixel is thus lifted from its 2D image plane into a frustum of potential 3D positions, based on intrinsic and extrinsic camera parameters. 2D to 3D lifting operation 318 may populate these frustums with context features, capturing both semantic and spatial information about the scene. 2D to 3D lifting operation 318 may then “splat” these features onto a predefined 3D grid (e.g., in a BEV representation), which allows the combination of information from multiple cameras into a unified 3D representation of the scene.

Once depth information is obtained from 2D to 3D lifting operation 318, the depth information can be combined with the 2D image coordinates to generate camera 3D features 320.

BEV projection unit 322 may then fuse and project LiDAR 3D features 314 and camera 3D features 320 into a BEV representation that includes fused BEV features 324. That is, fused BEV features 324 include both LiDAR 3D features 314 and camera 3D features 320. As described above, projecting camera and LiDAR features into a BEV representation is useful for applications such as autonomous driving, where understanding the spatial layout from a top-down perspective enhances scene comprehension and decision-making. BEV projection unit 322 may use one of several techniques to achieve a BEV projection, including lift, splat, and shoot methods. An example of a lift, splat, shoot is described below.

A “lift” technique involves transforming 2D camera features into 3D space before projecting them onto the BEV plane. This process is achieved by 2D to 3D lifting operation 318, as described above.

The “splat” technique focuses on projecting LiDAR points from LiDAR 3D features 314 directly into the BEV space and then splatting or spreading the associated features across the BEV grid. In this approach, each LiDAR point, along with its attributes (such as intensity or reflectivity), is projected onto the BEV plane. The features from the points are then distributed or “splatted” over the BEV grid cells they fall into, e.g., using a Gaussian kernel or other spreading functions to ensure smooth and continuous feature representation.

The “shoot” technique involves shooting or raycasting from the sensor's position to project features into the BEV space. For LiDAR, this means taking each point and directly projecting its position onto the BEV plane based on its horizontal and vertical angles. For camera features, raycasting can be used to project 2D image features into the 3D space and then onto the BEV plane. This method effectively handles occlusions and ensures that the features are accurately mapped to their correct positions in the BEV space.

In accordance with the techniques of this disclosure, BEV and height fusion unit 307 may be configured to generate a plurality of height maps from the 3D sensor features (e.g., LiDAR 3D features 314 and camera 3D features 320 at a plurality of times (e.g., time t, time t-1, to time t-N). More specifically, from the 3D representations of camera and LiDAR features, the height or elevation of objects can be extracted using the height encoder 326. Height encoder 326 may be a CNN encoder that is configured to extract heightmaps 328. For example, height encoder 326 may include a self-recursive height predictor that refines the height estimates across layers of a CNN, which better ensures that the encoder captures the vertical structure of objects accurately. Heightmaps 328 include an encoding of the height of objects on the BEV grid.

In computer vision, a height map, also known as a depth map or elevation map, is a representation of the 3D structure of a scene where each pixel value corresponds to the height or depth of that point relative to a reference plane. This map captures the topographical features of a surface, providing detailed information about the variations in elevation. The creation of a height map may include using sensors or techniques that can measure the distance from the sensor to the surface points, such as stereo vision, LiDAR, structured light, and time-of-flight cameras. The resulting map is typically a 2D grid where the intensity or color of each pixel indicates the height or depth of the corresponding point in the scene. Each point in the heightmap 328 corresponds to a specific location in the environment, allowing the system to determine the height of objects present at that location.

Since LiDAR 3D features 314 include absolute 3D information, height encoder 326 may use voxel heights from the voxelized point cloud data as supervision data. This eliminates the sparsity problem with LiDAR by combining heightmaps from camera 3D features 320 and LiDAR 3D features 314. Heightmaps 328 provide detailed elevation information, allowing the system to accurately model the vertical dimension of the environment. With explicit height encoding, BEV and height fusion unit 307 can encode the slope and elevation of terrain, better ensuring objects are properly localized even on uneven and elevated surfaces.

BEV and height fusion unit 307 may further include a height gradient map generation unit 330 that may generate a height gradient map 332 (HeightGrad map) from the plurality of height maps. In addition, height gradient map generation unit 330 may combine position encoding with the height gradient map. The position encoding may include one or more of a location of the sensor or vehicle as well as a pose of the sensor or vehicle.

Height gradient map generation unit 330 may generate HeightGrad map 332 by computing height gradients from previous heightmaps 328 generated at times t to t-N, along with position encoding to align heightmap features in space and time. HeightGrad map 332 represent the gradients or changes in height over time, capturing temporal variations in elevation. By analyzing changes in elevation over time, HeightGrad map 332 provides valuable insights into dynamic terrain features and evolving environmental conditions. Furthermore, by analyzing height gradients over extended periods, BEV and height fusion unit 307 can anticipate future terrain changes. HeightGrad map 332 captures temporal variations in terrain elevation, providing insights into how the environment's topography changes over time. This improves the ability to perceive dynamic terrain features such as potholes, road bumps, or construction zones more accurately.

BEV and heightmap fusion encoder 334 receives fused BEV features 324 generated at the current time t and HeightGrad map 332 generated at the current time t as input and fuses the information to generate height informed fused features that may be used by one or more decoders of perception task unit 309. BEV and heightmap fusion encoder 334 may include a multi-head self-attention mechanism within a transformer encoder that allows BEV and heightmap fusion encoder 334 to focus on different parts of the BEV/heightmap features capturing complex relationships within each feature set.

In general, fused features, such as height informed fused features, refers to the combined information obtained from integrating data from different modalities, such as HeightGrad map 332, and fused BEV features 324. The goal of feature fusion is to leverage the strengths of each modality to create a more comprehensive and accurate representation of the environment.

Cross-attention allows BEV and heightmap fusion encoder 334 to attend to features from one input sequence (e.g., fused BEV features 324) based on information from another sequence (e.g., HeightGrad map 332). Cross-attention between fused BEV features 324 and HeightGrad map 332, allows BEV and heightmap fusion encoder 334 to selectively focus on relevant information from each source during encoding. This mechanism facilitates the fusion of BEV and HeightGrad map features by allowing the model to incorporate context and spatial relationships between objects captured by both sources.

Perception task unit 309 may use the height informed fused features generated by BEV and heightmap fusion encoder 334 in various autonomous perception tasks with task-specific transformer decoder heads. FIG. 3 shows an example of a first decoder 336 for semantic occupancy prediction, a second decoder 338 for semantic segmentation, a third decoder 340 for lane tracking, and a fourth decoder 342 for 3D objection detection. Of course, more or fewer transfer decoders may be used.

For semantic segmentation, the height informed fused features provide comprehensive spatial information so that decoder 338 can classify the scene into semantic categories even on uneven terrain and at different elevations. For occupancy prediction, decoder 336 can predict the occupancy of each grid cell in the BEV representation, considering both the presence of objects and their elevation from the heightmap features contained within the height informed fused features. Leveraging the height informed fused features, decoder 340 may can better handle varying road elevations and slopes for lane tracking. Not limited to examples of FIG. 3, the integration of height information in height informed fused features may improve several other perception tasks, such as 3D Object Detection, Trajectory Prediction, and others.

Combining height information with fused BEV features provides several benefits, including enhanced spatial understanding, robustness to terrain variability, adaptability to dynamic environments, and efficient integration of multi-sensor data.

By combining BEV and heightmap features, BEV and height fusion unit 307 gains a more comprehensive understanding of the environment's spatial layout. BEV and height fusion unit 307 can more accurately model terrain elevation, slopes, and obstacles, leading to improved navigation and decision-making in complex outdoor environments.

The ability of perception task unit 309 to address terrain elevation and slopes makes it more robust to variations in the landscape. Perception task unit 309 can produce outputs that can better enable a vehicle (e.g., using ADAS 205) to navigate uneven terrain, such as hills, valleys, and ramps, with greater confidence, ensuring safe and efficient operation in diverse outdoor settings.

The robust perception capabilities of the techniques of this disclosure allows for adaptability to dynamic changes in the environment, such as moving obstacles, changing road conditions, and evolving terrain features. BEV and height fusion unit 307 can quickly update its understanding of the environment and make real-time adjustments to ensure safe and efficient operation in dynamic outdoor settings.

By fusing information from multiple sensors, such as LiDAR and cameras, the techniques of this disclosure leverage the complementary strengths of each sensor modality. BEV and height fusion unit 307 can exploit the rich 3D information from LiDAR for precise elevation measurements while utilizing the detailed visual information from cameras for object recognition and scene understanding.

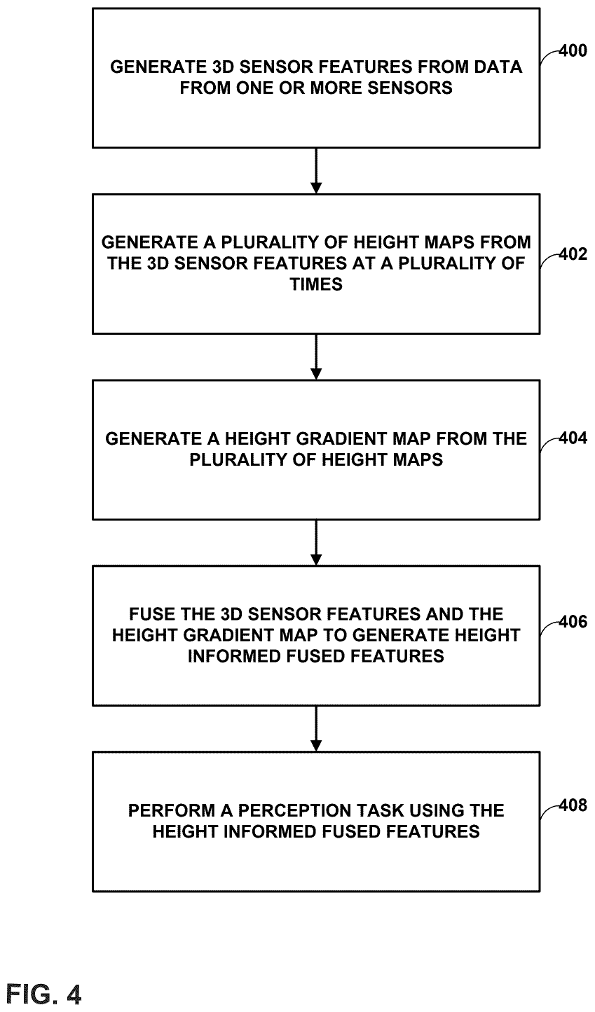

FIG. 4 is a flowchart illustrating an example process in accordance with the techniques of this disclosure. The techniques of FIG. 4 may be performed by one or more controller 114 of FIG. 1 and/or computing system 200. For ease of description, FIG. 4 will be described with reference to computing system 200.

Computing system 200 may be configured to perform one or more perception tasks using height informed fused features in accordance with the techniques of this disclosure. For example, computing system 200 may be configured to generate 3D sensor features from data from one or more sensors (400). In one example, the one or more sensors include a camera sensor and a LiDAR sensor. In this example, to generate the 3D sensor features from the one or more sensors, computing system 200 may be configured to receive point cloud data from the LiDAR sensor, generate, using a first feature extractor, LiDAR 3D features from the point cloud data, receive camera data from the camera sensor, and generate, using a second feature extractor, camera features from the camera data.

In another example, the one or more sensors include only one or more camera sensors. In other examples, the one or more sensors include a camera sensor and a radar sensor, or a camera sensor and a sonar sensor.

Computing system 200 may be further configured to perform a 2D to 3D lifting operation on the camera features to generate camera 3D features. In some examples, computing system 200 may perform the 2D to 3D lifting operation using learned projections and the point cloud data as supervision data.

Computing system 200 may be further configured to generate a plurality of height maps from the 3D sensor features at a plurality of times (402). In one example, to generate the plurality of height maps from the 3D sensor features at the plurality of times, computing system 200 may process respective LiDAR 3D features and respective camera 3D features with a height encoder at each of the plurality of times to produce the plurality of height maps. In one example, the height encoder uses the point cloud data as supervision data.

Computing system 200 may be further configured to generate a height gradient map from the plurality of height maps (404). To generate the height gradient map from the plurality of height maps, computing system 200 may be configured to compute height gradients from the plurality of height maps, and combine the height gradients with position encoding to generate the height gradient map. In one example, the position encoding includes one or more of location information and pose information. The height gradient map may include information indicating temporal variations in height over time in an area around the one or more sensors.

Computing system 200 may be further configured to fuse the 3D sensor features and the height gradient map to generate height informed fused features (406). In one example, to fuse the 3D sensor features and the height gradient map to generate height informed fused features, computing system 200 may be configured to fuse the 3D sensor features and the height gradient map using a transformer encoder with a self-attention mechanism to generate height informed fused features.

Computing system 200 may be further configured to perform a perception task using the height informed fused features (408). For example, computing system 200 may perform the perception task with a task-specific decoder using the height informed fused features as input. The perception task may include one or more of sematic segmentation, semantic occupancy prediction, lane tracking, or 3D object detection. Computing system 200 may be part of an ADAS, and may be configured to control a vehicle at least in part based on an output of the perception task.

The following numbered clauses illustrate one or more aspects of the devices and techniques described in this disclosure.
Clause 1. An apparatus configured for performing a perception task, the apparatus comprising: a memory; and processing circuitry connected to the memory, the processing circuitry configured to: generate 3D sensor features from data from one or more sensors; generate a plurality of height maps from the 3D sensor features at a plurality of times; generate a height gradient map from the plurality of height maps; fuse the 3D sensor features and the height gradient map to generate height informed fused features; and perform the perception task using the height informed fused features.
Clause 2. The apparatus of Clause 1, wherein the one or more sensors include a camera sensor and a LiDAR sensor, and wherein to generate the 3D sensor features from the one or more sensors, the processing circuitry is configured to: receive point cloud data from the LiDAR sensor; generate, using a first feature extractor, LiDAR 3D features from the point cloud data; receive camera data from the camera sensor; and generate, using a second feature extractor, camera features from the camera data.
Clause 3. The apparatus of Clause 2, wherein the processing circuitry is further configured to: perform a 2D to 3D lifting operation on the camera features to generate camera 3D features.
Clause 4. The apparatus of Clause 3, wherein to perform the 2D to 3D lifting operation, the processing circuitry is configured to: perform the 2D to 3D lifting operation using learned projections and the point cloud data as supervision data.
Clause 5. The apparatus of any of Clauses 3-4, wherein to generate the plurality of height maps from the 3D sensor features at the plurality of times, the processing circuitry is configured to: process respective LiDAR 3D features and respective camera 3D features with a height encoder at each of the plurality of times to produce the plurality of height maps.
Clause 6. The apparatus of Clause 5, wherein the height encoder uses the point cloud data as supervision data.
Clause 7. The apparatus of any of Clauses 1-6, wherein to generate the height gradient map from the plurality of height maps, the processing circuitry is configured to: compute height gradients from the plurality of height maps; and combine the height gradients with position encoding to generate the height gradient map.
Clause 8. The apparatus of Clause 7, wherein the position encoding includes one or more of location information and pose information.
Clause 9. The apparatus of any of Clauses 7-8, wherein the height gradient map includes information indicating temporal variations in height over time in an area around the one or more sensors.
Clause 10. The apparatus of any of Clauses 1-9, wherein to fuse the 3D sensor features and the height gradient map to generate height informed fused features, the processing circuitry is configured to: fuse the 3D sensor features and the height gradient map using a transformer encoder with a self-attention mechanism to generate height informed fused features.
Clause 11. The apparatus of any of Clauses 1-10, wherein to perform the perception task using the height informed fused features, the processing circuitry is configured to: perform the perception task with a task-specific decoder using the height informed fused features as input.
Clause 12. The apparatus of any of Clauses 1-11, wherein the perception task includes one or more of sematic segmentation, semantic occupancy prediction, lane tracking, or 3D object detection.
Clause 13. The apparatus of any of Clauses 1-12, wherein the one or more sensors include one or more camera sensors.
Clause 14. The apparatus of any of Clauses 1-12, wherein the one or more sensors include a camera sensor and a radar sensor.
Clause 15. The apparatus of any of Clauses 1-12, wherein the one or more sensors include a camera sensor and a sonar sensor.
Clause 16. The apparatus of any of Clauses 1-15, wherein the processing circuitry is part of an advanced driver assistance system (ADAS), and wherein the ADAS is configured to control a vehicle at least in part based on an output of the perception task.
Clause 17. A method for performing a perception task, the method comprising: generating 3D sensor features from data from one or more sensors; generating a plurality of height maps from the 3D sensor features at a plurality of times; generating a height gradient map from the plurality of height maps; fusing the 3D sensor features and the height gradient map to generate height informed fused features; and performing the perception task using the height informed fused features.
Clause 18. The method of Clause 17, wherein the one or more sensors include a camera sensor and a LiDAR sensor, and wherein generating the 3D sensor features from the one or more sensors comprises: receiving point cloud data from the LiDAR sensor; generating, using a first feature extractor, LiDAR 3D features from the point cloud data; receiving camera data from the camera sensor; and generating, using a second feature extractor, camera features from the camera data.
Clause 19. The method of Clause 18, further comprising: performing a 2D to 3D lifting operation on the camera features to generate camera 3D features.
Clause 20. The method of Clause 19, wherein performing the 2D to 3D lifting operation comprises: performing the 2D to 3D lifting operation using learned projections and the point cloud data as supervision data.
Clause 21. The method of any of Clauses 19-20, wherein generating the plurality of height maps from the 3D sensor features at the plurality of times comprises: processing respective LiDAR 3D features and respective camera 3D features with a height encoder at each of the plurality of times to produce the plurality of height maps.
Clause 22. The method of Clause 21, wherein the height encoder uses the point cloud data as supervision data.
Clause 23. The method of any of Clauses 17-22, wherein generating the height gradient map from the plurality of height maps comprises: computing height gradients from the plurality of height maps; and combining the height gradients with position encoding to generate the height gradient map.
Clause 24. The method of Clause 23, wherein the position encoding includes one or more of location information and pose information.
Clause 25. The method of any of Clauses 23-24, wherein the height gradient map includes information indicating temporal variations in height over time in an area around the one or more sensors.
Clause 26. The method of any of Clauses 17-25, wherein fusing the 3D sensor features and the height gradient map to generate height informed fused features comprises: fusing the 3D sensor features and the height gradient map using a transformer encoder with a self-attention mechanism to generate height informed fused features.
Clause 27. The method of any of Clauses 17-26, wherein performing the perception task using the height informed fused features comprises: performing the perception task with a task-specific decoder using the height informed fused features as input.
Clause 28. The method of any of Clauses 17-27, wherein the perception task includes one or more of sematic segmentation, semantic occupancy prediction, lane tracking, or 3D object detection.
Clause 29. The method of any of Clauses 17-28, wherein the one or more sensors include one or more camera sensors.
Clause 30. The method of any of Clauses 17-28, wherein the one or more sensors include a camera sensor and a radar sensor.
Clause 31. The method of any of Clauses 17-28, wherein the one or more sensors include a camera sensor and a sonar sensor.
Clause 32. The method of any of Clauses 17-31, further comprising: controlling a vehicle at least in part based on an output of the perception task.
Clause 33. A non-transitory computer-readable storage medium storing instructions that, when executed, cause one or more processors of a device configured to perform a perception task to: generate 3D sensor features from data from one or more sensors; generate a plurality of height maps from the 3D sensor features at a plurality of times; generate a height gradient map from the plurality of height maps; fuse the 3D sensor features and the height gradient map to generate height informed fused features; and perform the perception task using the height informed fused features.
Clause 34. The non-transitory computer-readable storage medium of Clause 33, wherein the instructions further cause the one or more processors to perform any combination of techniques of Clauses 17-32.

Clause 35. A device configured to perform a perception task, the device comprising: means for generating 3D sensor features from data from one or more sensors; means for generating a plurality of height maps from the 3D sensor features at a plurality of times; means for generating a height gradient map from the plurality of height maps; means for fusing the 3D sensor features and the height gradient map to generate height informed fused features; and means for performing the perception task using the height informed fused features.
Clause 36. The device of Clause 35, further comprising means for performing any combination of techniques of Clauses 17-32.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured for performing a perception task, the apparatus comprising:
a memory; and
processing circuitry connected to the memory, the processing circuitry configured to:
generate 3D sensor features from data from one or more sensors;
generate a plurality of height maps from the 3D sensor features at a plurality of times;
generate a height gradient map from the plurality of height maps;
fuse the 3D sensor features and the height gradient map to generate height informed fused features; and
perform the perception task using the height informed fused features.

2. The apparatus of claim 1, wherein the one or more sensors include a camera sensor and a LiDAR sensor, and wherein to generate the 3D sensor features from the one or more sensors, the processing circuitry is configured to:
receive point cloud data from the LiDAR sensor;
generate, using a first feature extractor, LiDAR 3D features from the point cloud data;
receive camera data from the camera sensor; and
generate, using a second feature extractor, camera features from the camera data.

3. The apparatus of claim 2, wherein the processing circuitry is further configured to:
perform a 2D to 3D lifting operation on the camera features to generate camera 3D features.

4. The apparatus of claim 3, wherein to perform the 2D to 3D lifting operation, the processing circuitry is configured to:
perform the 2D to 3D lifting operation using learned projections and the point cloud data as supervision data.

5. The apparatus of claim 3, wherein to generate the plurality of height maps from the 3D sensor features at the plurality of times, the processing circuitry is configured to:
process respective LiDAR 3D features and respective camera 3D features with a height encoder at each of the plurality of times to produce the plurality of height maps.

6. The apparatus of claim 5, wherein the height encoder uses the point cloud data as supervision data.

7. The apparatus of claim 1, wherein to generate the height gradient map from the plurality of height maps, the processing circuitry is configured to:
compute height gradients from the plurality of height maps; and
combine the height gradients with position encoding to generate the height gradient map.

8. The apparatus of claim 7, wherein the position encoding includes one or more of location information and pose information.

9. The apparatus of claim 7, wherein the height gradient map includes information indicating temporal variations in height over time in an area around the one or more sensors.

10. The apparatus of claim 1, wherein to fuse the 3D sensor features and the height gradient map to generate height informed fused features, the processing circuitry is configured to:
fuse the 3D sensor features and the height gradient map using a transformer encoder with a self-attention mechanism to generate height informed fused features.

11. The apparatus of claim 1, wherein to perform the perception task using the height informed fused features, the processing circuitry is configured to:
perform the perception task with a task-specific decoder using the height informed fused features as input.

12. The apparatus of claim 1, wherein the perception task includes one or more of sematic segmentation, semantic occupancy prediction, lane tracking, or 3D object detection.

13. The apparatus of claim 1, wherein the one or more sensors include one or more camera sensors.

14. The apparatus of claim 1, wherein the one or more sensors include a camera sensor and a radar sensor.

15. The apparatus of claim 1, wherein the one or more sensors include a camera sensor and a sonar sensor.

16. The apparatus of claim 1, wherein the processing circuitry is part of an advanced driver assistance system (ADAS), and wherein the ADAS is configured to control a vehicle at least in part based on an output of the perception task.

17. A method for performing a perception task, the method comprising:
generating 3D sensor features from data from one or more sensors;
generating a plurality of height maps from the 3D sensor features at a plurality of times;
generating a height gradient map from the plurality of height maps;
fusing the 3D sensor features and the height gradient map to generate height informed fused features; and
performing the perception task using the height informed fused features.

18. The method of claim 17, wherein the one or more sensors include a camera sensor and a LiDAR sensor, and wherein generating the 3D sensor features from the one or more sensors comprises:
receiving point cloud data from the LiDAR sensor;
generating, using a first feature extractor, LiDAR 3D features from the point cloud data;
receiving camera data from the camera sensor; and
generating, using a second feature extractor, camera features from the camera data.

19. The method of claim 18, further comprising:
performing a 2D to 3D lifting operation on the camera features to generate camera 3D features.

20. The method of claim 19, wherein performing the 2D to 3D lifting operation comprises:
performing the 2D to 3D lifting operation using learned projections and the point cloud data as supervision data.

21. The method of claim 19, wherein generating the plurality of height maps from the 3D sensor features at the plurality of times comprises:
processing respective LiDAR 3D features and respective camera 3D features with a height encoder at each of the plurality of times to produce the plurality of height maps.

22. The method of claim 21, wherein the height encoder uses the point cloud data as supervision data.

23. The method of claim 17, wherein generating the height gradient map from the plurality of height maps comprises:
computing height gradients from the plurality of height maps; and
combining the height gradients with position encoding to generate the height gradient map.

24. The method of claim 23, wherein the position encoding includes one or more of location information and pose information.

25. The method of claim 23, wherein the height gradient map includes information indicating temporal variations in height over time in an area around the one or more sensors.

26. The method of claim 17, wherein fusing the 3D sensor features and the height gradient map to generate height informed fused features comprises:
fusing the 3D sensor features and the height gradient map using a transformer encoder with a self-attention mechanism to generate height informed fused features.

27. The method of claim 17, wherein performing the perception task using the height informed fused features comprises:
performing the perception task with a task-specific decoder using the height informed fused features as input.

28. The method of claim 17, wherein the perception task includes one or more of sematic segmentation, semantic occupancy prediction, lane tracking, or 3D object detection.

29. The method of claim 17, wherein the one or more sensors include one or more camera sensors.

30. The method of claim 17, wherein the one or more sensors include a camera sensor and a radar sensor.

31. The method of claim 17, wherein the one or more sensors include a camera sensor and a sonar sensor.

32. The method of claim 17, further comprising:
controlling a vehicle at least in part based on an output of the perception task.

33. A device configured to perform a perception task, the device comprising:
means for generating 3D sensor features data from one or more sensors;
means for generating a plurality of height maps from the 3D sensor features at a plurality of times;
means for generating a height gradient map from the plurality of height maps;
means for fusing the 3D sensor features and the height gradient map to generate height informed fused features; and
means for performing the perception task using the height informed fused features.
